(19) United States
(12) Patent Application Publication
(10) Pub. No.: US 2018/0096587 A1
(43) Pub. Date: Apr. 5, 2018

(54) TRANSMITTING WIRELESS ALERT MESSAGES AT SUB-CELL GRANULARITY

(71) Applicants: Alcatel-Lucent USA Inc., Murray Hill, NJ (US); Alcatel-Lucent Deutschland AG, Stuttgart (DE)

(72) Inventors: Bilgehan Erman, Weehawken, NJ (US); Qi Liao, Stuttgart (DE); Lawrence O'Gorman, Madison, NJ (US); Simon Yiu, Jersey City, NJ (US)

(21) Appl. No.: 15/286,214

(22) Filed: Oct. 5, 2016

(51) Int. Cl. G08B 25/01; G08B 25/10

(52) U.S. Cl. CPC G08B 25/016; G08B 25/10

(57) ABSTRACT

A server receives signals indicating an alert condition for a location that is defined by a set of location attributes and identifies one or more base stations that serve one or more cells that overlap with the location, which encompasses less than all of the cells. The server transmits a message to the one or more base stations identifying the alert condition and including the set of location attributes. A user equipment receives the message identifying the alert condition and including the set of location attributes that define the location of the alert condition. The user equipment compares a location of the user equipment to the set of location attributes and generates an alert in response to the location of the user equipment being within the location of the alert condition.

### BACKGROUND

### Field of the Disclosure

The present disclosure relates generally to wireless communication systems and, more particularly, to alert messages transmitted in wireless communication systems.

### Description of the Related Art

Nearly ubiquitous wireless connectivity enables people to remain in constant communication with each other and with services provided by wireless communication systems. Emergency warning systems are therefore able to reach large numbers of users via wireless connections to user equipment such as smart phones, tablets, smart watches, and the like. Requirements for wireless emergency warning systems are described in the Third Generation Partnership Project (3GPP) Technical Specification (TS) 22.268-Public Warning System (PWS). These international standards are supplemented by country specific standards such as the Commercial Mobile Alert System (CMAS) in the United States, the Earthquake and Tsunami Warning System (ETWS) in Japan, the EU-ALERT system in Europe, and others. Emergency notifications are typically sent to multiple base stations or access points for transmission to user equipment within the geographic areas (or cells) served by the base stations or access points because these warning systems are intended to alert large numbers of people distributed over a relatively large area, e.g., in the event of natural disasters such as hurricanes, tornadoes, earthquakes, or tsunamis.

A system implementation perspective of a public warning system is provided in the 3GPP Technical Specification 23.041-Technical realization of Cell Broadcast Service (CBS). The interface of the CBC with the EPC is described in the 3GPP Technical Specification 29.168—Cell Broadcast Center (CBC) interfaces with the EPC. The 3GPP standards TS 22.268, TS 23.041, and TS 29.168 all establish the granularity of the distribution of the CBS warning notifications to be at the radio network cell level or at radio network Tracking Area level. Cell level corresponds to base station or an eNodeB and the Tracking Area corresponds to a group of base stations or eNodeBs that are geographically close to one another. Also in practice, as discussed in the standards, public land mobile network (PLMN) operators send warning notifications at the cell level or the Tracking Area level. For example, TS 22.268 establishes the granularity of the distribution of warning notifications to allow public land mobile network (PLMN) operators to define a notification area at the cell level, the eNodeB level, the radio network controller (RNC) level, or at coarser levels of granularity. For another example, the 3GPP TS 23.041 Cell Broadcast Service defines the granularity of the distribution area for warning messages to be a cell.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is an illustration of a geographic region that includes a danger zone according to some embodiments.

FIG. 3 is a flow diagram of a method for providing alert messages to base stations that serve cells that overlap a danger zone according to some embodiments.

FIG. 4 is a flow diagram of a method for filtering alert messages at user equipment based on location attributes received with the alert messages according to some embodiments.

FIG. 5 is a block diagram of a wireless communication system that supports providing alert messages at a sub-cell granularity according to some embodiments.

FIG. 6 is a block diagram illustrating functional components of a wireless communication system according to some embodiments.

FIG. 7 is a diagram of messaging flow between cell broadcast service (CBS) functional components according to some embodiments.

FIG. 8 is a diagram illustrating contents of a write-replace warning request message according to some embodiments.

### DETAILED DESCRIPTION

Many emergencies are more localized than most natural disasters and, consequently, affect much smaller numbers of users in very particular locations. For example, most fatal collisions between motorized vehicles and pedestrians or cyclists occur at particular intersections of streets in cities. These locations can be identified as danger zones using accident statistics and the danger zones can be monitored using devices such as cameras, motion detectors, collision warning systems, and the like. The data collected by the monitoring devices can be used to identify dangerous conditions within the danger zones, such as a vehicle traveling in excess of the speed limit. This information could be used to warn pedestrians or cyclists in the danger zone or a portion of the danger zone that is affected by the dangerous condition. For another example, utility companies or the fire department can monitor buildings for dangerous conditions such as gas leaks or fires. This information can be used to warn occupants to exit the building using the emergency exits. However, the coarse granularity of conventional emergency warning systems causes the emergency messages to be broadcast to all user equipment within at least one cell. Most users within the cell will be too far from the danger zone to be affected by the dangerous conditions and these users will perceive the emergency message to be pointless (at best) or annoying and intrusive (at worst), which may lead them to ignore or disable the emergency warning system.

Alert messages including warning messages or emergency messages transmitted by an emergency warning system implemented in a wireless communication system can be targeted to users at a sub-cell level by transmitting a message identifying an emergency condition and a set of location attributes that defines a geographic area that is affected by the emergency condition. The message and the set of location attributes can be generated by a network entity such as a cell broadcast entity (CBE). The location attributes related to sub-cell broadcasts can include geographic coordinates such as latitudes and longitudes provided by a global navigation satellite system such as a Global Positioning System (GPS) or Galileo, altitudes, or other coordinates. The location attributes can also include other information defining a location such as an identity of a aircraft in flight, a bus, a train car, a ship, and the like.

The network entity identifies one or more cells that overlap with the geographic area indicated by the set of location attributes and provides the message to one or more base stations for transmission into the identified cells. User equipment within the cells filter the message based on the set of location attributes received with the message. For example, the user equipment can compare its current GPS coordinates to the set of location attributes to determine whether the user equipment is within the specific geographic area. If so, the user equipment generates a user alert based on the message. If not, the user equipment discards the message and does not provide a user alert so that the user is not unnecessarily bothered or distracted by an irrelevant message. The emergency warning system can therefore provide warning messages to target zones of at a granularity that is smaller than a cell using the existing communications infrastructure and new capabilities at the server and client endpoint applications.

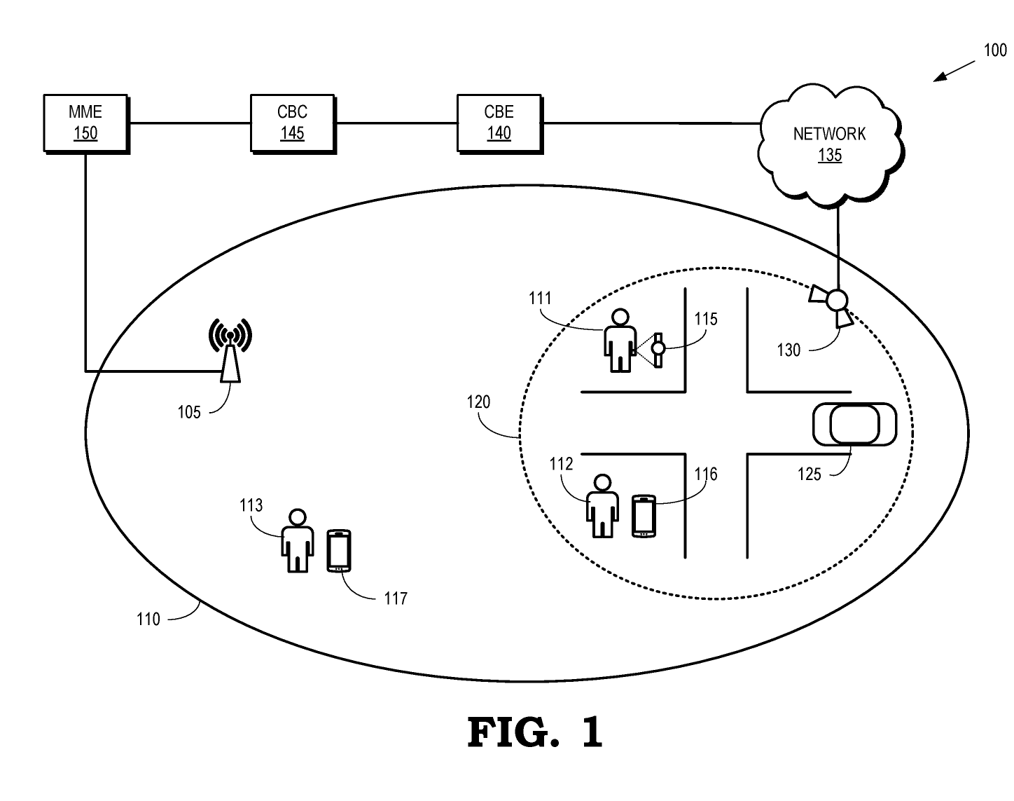

FIG. 1 is a block diagram of a wireless communication system 100 according to some embodiments. Some embodiments of the wireless communication system 100 implement a Cell Broadcast Service (CBS), which may be implemented in systems that operate according to GSM, UMTS, and E-UTRAN, which are also known as 2G, 3G, and 4G mobile network technologies. Some embodiments of the techniques disclosed herein may also be implemented in future radio networks, such as 5G. In the interest of clarity, CBS inter-operation with the standard wireless network and the wireless communication system 100 is described in reference to the E-UTRAN 4G radio network and the related core network functions called Evolved Packet Core (EPC).

The wireless communication system 100 includes one or more base stations 105 that provide wireless connectivity within a corresponding geographic area or cell 110. One or more users 111, 112, 113 (collectively referred to herein as “the users 111-113”) are located within the cell 110 and are associated with corresponding user equipment 115, 116, 117 (collectively referred to herein as “the user equipment 115-117”). For example, the user 111 is wearing a smart watch 115 that is configured for wireless connectivity with the wireless communication system 100 via the base station 105. For another example, the user 112 is carrying a smartphone 116 that is configured for wireless connectivity with the wireless communication system via the base station 105. For yet another example, the user 113 is carrying a wireless-enabled tablet 117 that is configured for wireless connectivity with the wireless communication system via the base station 105. More or fewer users associated with more or fewer user equipment (or different types of user equipment) can be present in the wireless communication system 100 in some embodiments.

Events can occur that potentially impact the health or well-being of the users 111-113 while they are within the geographic area encompassed by the cell 110. The wireless communication system 100 is therefore configured to provide messages to the user equipment 115-117 to notify some or all of the users 111-113 in response to alert conditions associated with events occurring in the geographic area encompassed by the cell 110. As used herein, the term “alert condition” refers to situations or circumstances that one or more of the users 111-113 are likely to want to be made aware of, e.g., because the alert condition can potentially affect the health or well-being of the users 111-113. Alert conditions can also be referred to as “warning conditions,” “emergency conditions,” and the like. Examples of alert conditions include vehicles traveling at high speeds or moving erratically, gas leaks in a building, a fire in a building, an emergency condition in a vehicle such as an airplane or a bus or a train car or a ship, and the like.

Many alert conditions only arise in a subset of the area encompassed by the cell 110. These areas can be referred to as “danger zones” and they can be identified using accident statistics or other historical information that indicates a relatively high likelihood that accidents occur within the danger zone. For example, a danger zone 120 in the cell 110 corresponds to a street intersection that has a particularly high frequency of traffic accidents, which may involve vehicles, pedestrians, or bicyclists. The danger zone 120 is therefore monitored to detect alert conditions such as a vehicle 125 traveling in excess of the speed limit or driving erratically. Monitoring is performed by a monitoring element 130 such as a road side agent (RSA), a camera, a motion detector, a collision warning system, and the like. Although the monitoring element 130 is shown as a single external device in FIG. 1, some embodiments of the wireless communication system 100 include additional monitoring elements that can be deployed at other locations, as well as in or on vehicles such as the vehicle 125. Furthermore, a geographic area does not have to be identified as a danger zone in order to be monitored for alert conditions. For example, buildings can be monitored for fires or gas leaks even though the likelihood of a fire or a gas leak is small in any individual building.

The wireless communication system 100 includes a network 135 such as an intranet, an Internet, a wireless communication network, and the like. Some embodiments of the network 135 are able to receive signals generated by the monitoring element 130. The network 135 is also configured to convey signals to a server such as a cell broadcast entity (CBE) 140 that can be implemented as part of an evolved universal terrestrial radio access network (E-UTRAN). The CBE 140 is configured to receive the signals and then use the information conveyed by the signals (such as attributes of an alert condition) to generate/format messages for broadcasting within the cell 110. The CBE 140 is connected to a CBC 145 that is responsible for managing broadcast messages received from the CBE 140. Examples of responsibilities of the CBC 145 are described in 3GPP TS 23.041, which is incorporated herein in its entirety by reference.

One or more mobility management entities (MMES) 150 are configured to receive messages originated by the CBE 140 and formatted and generated by the CBC 145, as described in 3GPP TS 23.041. The MME 150 supports an interface for communication with the CBC 145. For example, the MME 150 can support an SBc interface to the CBC 145. The MME 150 also supports an interface for communication with one or more base stations such as the base station 105. For example, the MME 150 implements an S1-MME protocol stack to support a corresponding S1-MME interface to the base station 105. In the interest of clarity, a single MME 150 is shown in FIG. 1. However, some embodiments of the wireless communication system 100 include additional MMES 150.

The monitoring element 130 generates signals in response to detecting alert conditions within a boundary of the danger zone 120. For example, the monitoring element 130 can generate a warning signal in response to detecting the vehicle 125 moving at a speed in excess of the speed limit for the streets near the intersection within the boundary of the danger zone 120. The monitoring element 130 transmits the signals into a network 135 such as an intranet, an Internet, a wireless communication network, and the like. The network 135 conveys the signals to the CBE 140, which can create messages for transmission to the user equipment 115-117 via the base station 105. Not all of the users 111-113 want to receive messages that notify them of alert conditions within the danger zone 120. For example, the users 111, 112 are within the boundary of the danger zone 120 and are therefore likely to want to receive notifications of alert conditions within the danger zone 120. However, the user 113 is outside the boundary of the danger zone 120 and is therefore unlikely to want to receive notifications of alert conditions within the danger zone 120.

In order to support the selective provision of alerts to the users 111-113 by the corresponding user equipment 115-117 at a sub-cell granularity, location attributes are attached to the messages that are broadcast by the base station 105. Some embodiments of the location attributes define a boundary of a region that is associated with the alerts. Examples of location attributes include Global Positioning System (GPS) coordinates that define boundaries of the danger zone 120, Galileo coordinates that define the boundaries of the danger zone 120, and an altitude (or range of altitudes) of the danger zone 120. Locations associated with alert conditions can also be indicated by other location attributes such as a vehicle identifier that identifies a vehicle associated with an alert condition or a building identifier that identifies a building associated with the alert condition. Some embodiments of the messages also include additional target attributes. Examples of target attributes include a predicted time of an event associated with the alert condition, a description of the event (e.g., speeding car, fire, gas leak, etc.), a type of a target node that is intended to receive the message (such as a smart watch 115 or a smart phone 116), a type of an originating node for the event (such as the vehicle 125), time of event origination, a velocity of the originating node, or a predicted path of the originating node. Some embodiments of the monitoring element 130 provide the location attributes that define the danger zone 120 in the signals that are transmitted to the CBE 140 via the network 135.

The CBE 140 incorporates the location attributes (and, optionally, the target attributes) into the messages that are forwarded to the CBC 145. Some embodiments of the message also include a “warning type” that indicates that the message includes an alert or warning. In response to receiving the messages, the CBC 145 identifies the MME 150 (and potentially other MMES that are not shown in FIG. 1) that are connected to the base station 105 (and potentially other base stations that are not shown in FIG. 1) that provides wireless connectivity within the cell 110 that overlaps with the boundary of the danger zone 120. As discussed herein, the boundary of the danger zone 120 encompasses less than all of the cell 110. The boundary of the danger zone 120 also encompasses less than all of any of the other cells that may be served by other base stations in the wireless communication system 100. The base station 105 then transmits the messages including the location attributes (and, optionally, the target attributes) over an air interface towards the user equipment 115-117 within the cell 110.

The user equipment 115-117 are configured to filter the messages based on comparisons of the locations of the user equipment 115-117 to locations indicated by the location attributes in the message. For example, the user equipment 115, 116 can generate alerts in response to determining that the locations of the user equipment 115, 116 are within the danger zone 120, as indicated by the location attributes. For another example, the user equipment 117 can bypass generating alerts (and drop the message) in response to determining that the location of the user equipment 117 is outside of the danger zone 120, as indicated by the location attributes. Some embodiments of the user equipment 115-117 are also configured to filter the message is based on target attributes included in the message. For example, the danger zone 120 can be determined dynamically based on a current time, a previous location of the vehicle 125, a velocity of the vehicle 125, a predicted path of the vehicle 125, or other information. The user equipment 115-117 can calculate the current location of the danger zone 120 and then compare the current location of the danger zone 120 to their current locations to determine whether to provide an alert or to drop the message and bypass providing an alert.

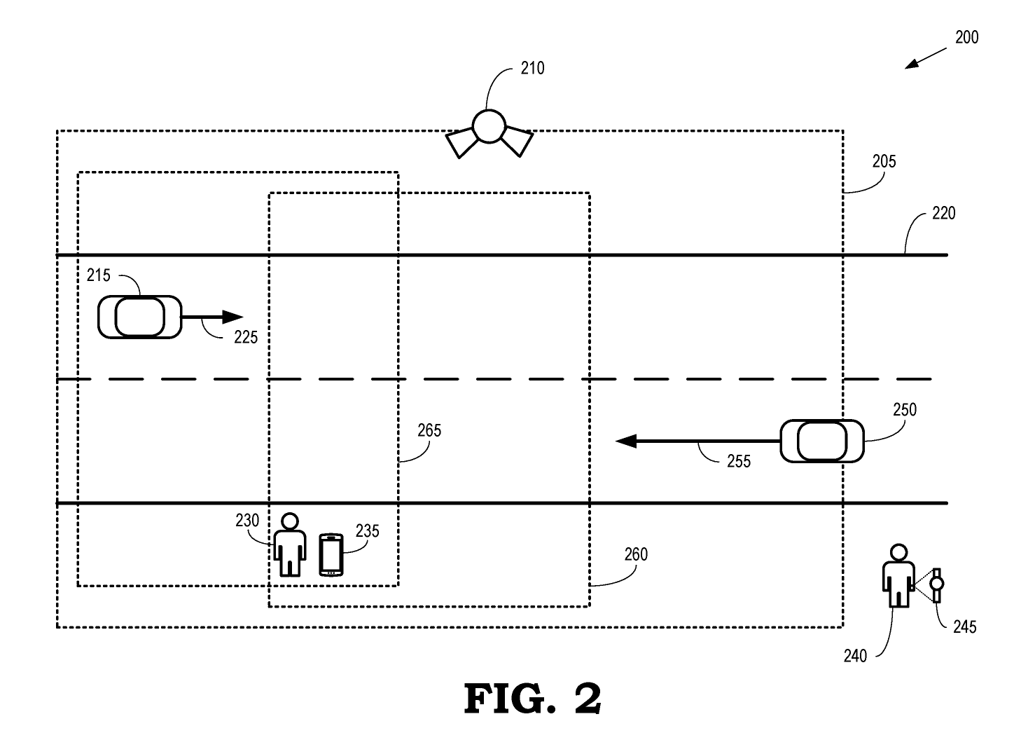

FIG. 2 is an illustration of a geographic region 200 that includes a danger zone 205 according to some embodiments. The danger zone 205 corresponds to some embodiments of the danger zone 120 shown in FIG. 1. The danger zone 205 is monitored by a monitoring element 210 that corresponds to some embodiments of the monitoring element 130 shown in FIG. 1. The danger zone 205 includes a vehicle 215 traveling on a road 220 at a velocity that is below the speed limit for the illustrated portion of the road 220, as indicated by the arrow 225. A user 230 and the user's smart phone 235 are located alongside the road 220 within the danger zone 205. Another user 240 and the user's smart watch 245 are located alongside the road 220 outside of the danger zone 205.

At a first time, the monitoring element 210 detects the presence of a vehicle 250 entering the danger zone 205 traveling at a velocity that is in excess of the speed limit for the illustrated portion of the road 220, as indicated by the arrow 255. In response to detecting the vehicle 250, the monitoring element 210 generates signals to indicate an alert condition within the danger zone 205. Some embodiments of the monitoring element 210 generate signals including location attributes that define a region 260 that is threatened by the presence of the speeding vehicle 250 at the first time. The location attributes can include coordinates that define the boundaries of the region 260. The user equipment 235 can use the location attributes to determine that its location is within the region 260 and therefore the user equipment 235 provides an alert in response to the message including the location attributes. The user equipment 245 determines that its location is outside of the region 260 and therefore the user equipment 245 does not provide an alert in response to the message.

The monitoring element 210 can also generate target attributes that define the location of the vehicle 250 at the first time, the velocity 255 of the vehicle 250 at the first time, and the like. The target attributes are included in the message transmitted to warn users within the danger zone of the presence of the speeding vehicle 250. This information can be used to update the region that is threatened by the speeding vehicle 250. For example, the user equipment 235 can use the location attributes and the target attributes to determine that the region 265 is threatened by the speeding vehicle 250 during a later (second) time interval. The second time interval is later than the first time and so the region 265 is further down the road 220 in the direction of the velocity 255 than the region 260. The user equipment 235 is still in the region 265 at the second time interval and so the user equipment 235 provides an alert in response to receiving the message. For another example, if the vehicle 215 is wireless enabled (or includes user equipment), the vehicle 215 can use the location attributes and the target attributes in the message to determine that the vehicle 215 is within the region 265 at the second time, even though the vehicle 215 was not within the region 260 at the first time. The vehicle 215 (or and included user equipment) can therefore provide an alert at the second time in response to receiving the message.

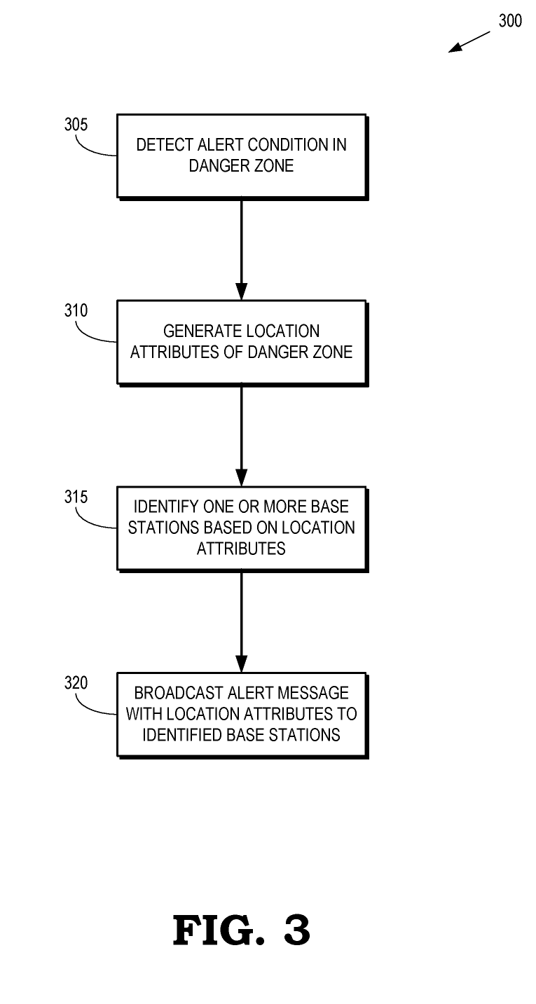

FIG. 3 is a flow diagram of a method 300 for providing alert messages to base stations that serve cells that overlap a danger zone according to some embodiments. The method 300 is implemented in some embodiments of the wireless communication system 100 shown in FIG. 1.

At block 305, an alert condition is detected in a danger zone. For example, a monitoring element can detect an event that gives rise to an alert condition, such as a speeding or erratically driven vehicle, a fire, a gas leak, and the like. The monitoring element can then generate a signal that identifies the alert condition, as discussed herein.

At block 310, location attributes of the danger zone are generated. The location attributes can be generated by the monitoring element or by another server implemented in the wireless communication system. A location attribute set can be represented as:

L={l₁,l₂, . . . ,lₙ}

where l₁, l₂, . . . , lₙ are individual location attributes. Target location attributes that represent a region within the danger zone that is associated with the alert condition can be represented as:

L′={l|lεL}

At block 315, the location attributes are used to identify one or more base stations that serve cells that overlap the region identified by the target location attributes. The set of radio access nodes, base stations, cells, or access points that serve the cells in the wireless communication system can be represented as:

C={c₁,c₂, . . . ,cₙ}

The location attributes of the cells can be represented as:

loc(c)={l|lεL [symbol] location of c=l,cεC}

A mapping of the location attribute set to the cells is defined as:

ƒ: L→C

The set of cells that include any one of the target location attributes is therefore:

ƒ(L′,C)={c|loc(c)εL′,cεC}

The set of cells indicated by application of the function (ƒᵢ) overlaps the region associated with the alert condition. The overlapping set of cells can be identified by a server such as the CBE 140 or the CBC 145 shown in FIG. 1. The overlapping set of cells can also be used to identify one or more MMES that are connected to the base stations that serve the overlapping set of cells.

At block 320, an alert message including the location attributes (and, optionally, one or more target attributes) is broadcast to the base stations that serve the set of cells that overlaps the region associated with the alert condition. For example, a CBC transmits the alert message and associated attributes to one or more MMES, which then forwards the alert messages to the identified set of base stations.

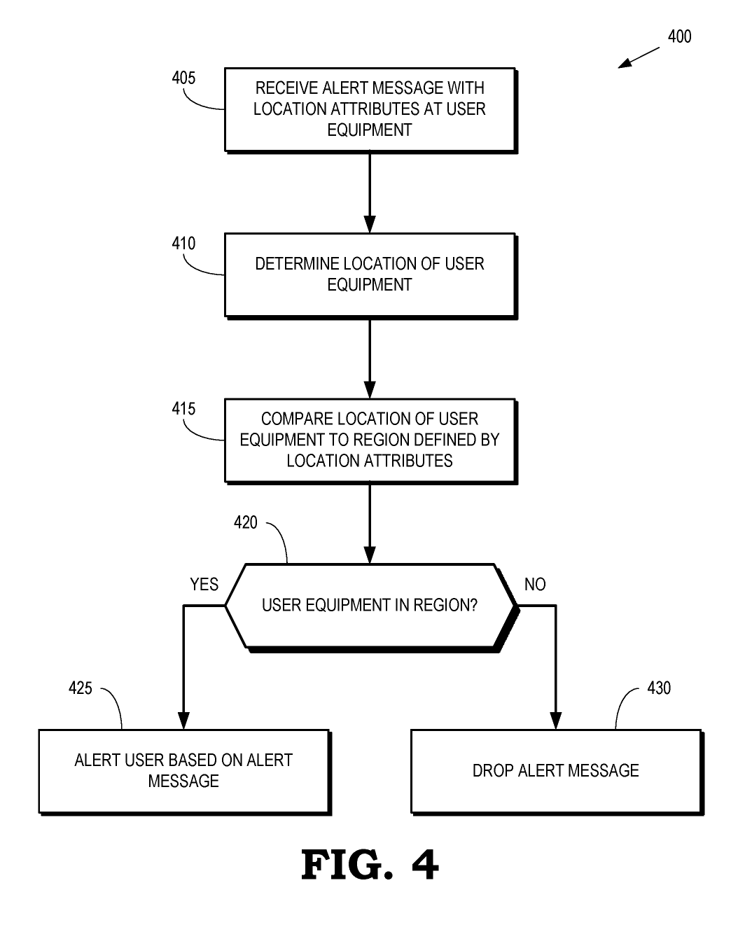

FIG. 4 is a flow diagram of a method 400 for filtering alert messages at user equipment based on location attributes received with the alert messages according to some embodiments. The method 400 is implemented in some embodiments of the user equipment 115-117 shown in FIG. 1 and the user equipment 235, 245 shown in FIG. 2.

At block 405, the user equipment receives an alert message including location attributes that define a region or location associated with the alert message. For example, the Target location attributes that represent a region within the danger zone that is associated with the alert condition can be represented as:

L′={l|lεL}.

Some embodiments of the alert message also include one or more target attributes, as discussed herein.

At block 410, the user equipment determines its current location. For example, the user equipment they use GPS functionality implemented by the user equipment to determine its current GPS coordinates. However, other location determination techniques can also be used to determine other coordinates that represent the location of the user equipment, such as Galileo coordinates. The user equipment can also determine its location based on whether the user equipment is within a building or a vehicle such as an airplane in flight, a bus, a train car, and the like. The location of the user equipment can be represented by user location attributes from a set that is represented as:

U={u₁,u₂, . . . ,uₙ}

The location attributes of the user equipment can be represented as:

loc(u)={l|lεL [symbol] location of u=l,uεU}

At block 415, the user equipment compares the location of user equipment to the region defined by the location attributes included in the alert message. A mapping of the location attributes set to the set of user equipment at that location is defined as:

g:L→U

g(L′,U)={u|loc(u)εL′,uεU}

The filtering of the alert message can then be performed based on an indicator of a match between the location of the user equipment and the region indicated by the location attributes received in the alert message. For any user equipment, the indicator function can be represented as:

$$indicator ( {L}^{′} , u ) = \{ \begin{matrix}True if loc ( u ) ∈ {L}^{′} , u ∈ U \\ False if loc ( u ) ∉ {L}^{′} , u ∈ U\end{matrix}$$

This value of the indicator shows whether the user equipment is within the region defined by the location attributes included in the alert message.

At decision block 420, the user equipment determines whether it is located in the region defined by the location attributes, e.g., using the indicator value (g). If so, the user equipment generates an alert to notify the user based on the alert message at block 425. Examples of alerts include visual alerts, auditory alerts, vibratory alerts, and the like. If the user equipment determines that it is not located in the region defined by the location attributes, the user equipment filters the alert and drops the alert message (at block 430). The user equipment does not provide an alert for filtered or dropped alert messages.

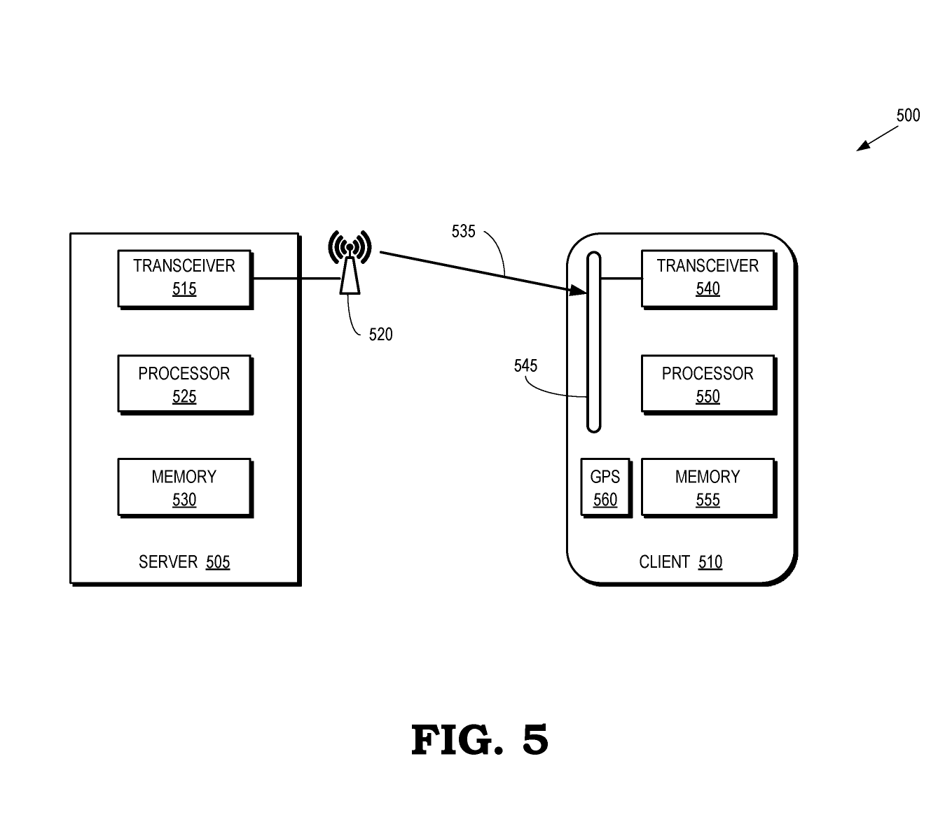

FIG. 5 is a block diagram of a wireless communication system 500 that supports providing alert messages at a sub-cell granularity according to some embodiments. The wireless communication system 500 includes a server 505 that is implemented as some embodiments of the CBE 140 or the CBC 145 shown in FIG. 1. Although a single server 505 shown in FIG. 5 in the interest of clarity, some embodiments of the wireless communication system 500 can implement different portions of the functionality in different servers. For example, individual servers can be used to implement the CBE 140, the CBC 145, and the MME 150 shown in FIG. 1. The wireless communication system 500 also includes a client 510 that is used to implement some embodiments of the user equipment 115-117 shown in FIG. 1 and the user equipment 235, 245 shown in FIG. 2.

The server 505 includes a transceiver 515 that is coupled to an eNodeB 520 for transmitting and receiving signals such as signals exchanged with the client 510. The transceiver 515 can be implemented as a single integrated circuit (e.g., using a single ASIC or FPGA) or as a system-on-a-chip (SOC) that includes different modules for implementing the functionality of the transceiver 515. The server 505 also includes a processor 525 and a memory 530. The processor 525 can be used to execute instructions stored in the memory 530 and to store information in the memory 530 such as the results of the executed instructions. The server 505 is configured to generate alert messages in response to alert conditions and the transceiver 515 can then transmit the alert messages via the antenna 520, as indicated by the arrow 535. The alert messages include location attributes and, optionally, additional target attributes. The server 505 is therefore able to perform some embodiments of the method 300 shown in FIG. 3 and the method 400 shown in FIG. 4.

The client 510 includes a transceiver 540 that is coupled to an antenna 545 for transmitting and receiving signals such the alert messages 535 received from the eNodeB 520. The transceiver 540 can be implemented as a single integrated circuit (e.g., using a single ASIC or FPGA) or as a system-on-a-chip (SOC) that includes different modules for implementing the functionality of the transceiver 540. The client 510 also includes a processor 550 and a memory 555. The processor 550 can be used to execute instructions stored in the memory 555 and to store information in the memory 555 such as the results of the executed instructions. The client 510 also includes a global navigation system receiver such as the GPS receiver 560. The processor 550 is configured to filter the alert messages 535 based on the received location attributes, location information provided by the GPS receiver 560, and, optionally, the target attributes. The processor 550 is also configured to provide alerts based on the filtered alert messages and, optionally, the filtered target attributes. The client 510 is therefore able to perform some embodiments of the method 300 shown in FIG. 3 and the method 400 shown in FIG. 4.

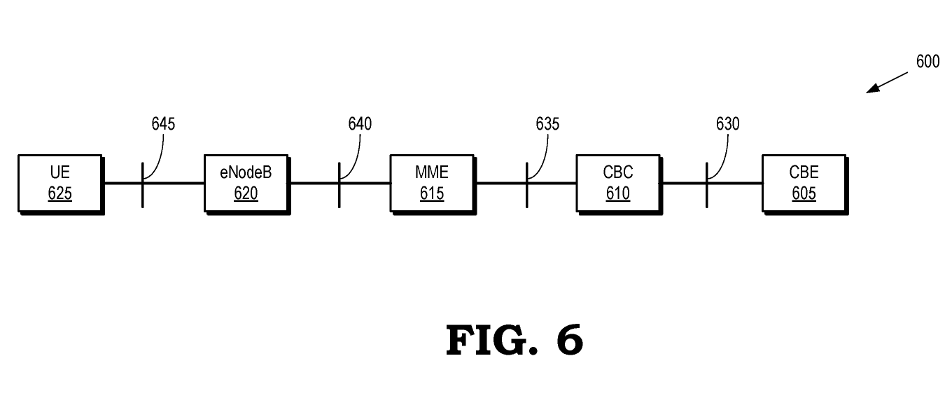

FIG. 6 is a block diagram illustrating functional components of a wireless communication system 600 according to some embodiments. In some embodiments, the functional components of the wireless communication system 600 are used to implement a CBS, such as described in TS 23.041. For example, CBS warning notification requests are created by the Cell Broadcast Entities (CBE) 605. A CBC 610 is the entity that assembles the warning notification messages according to the specified standard. A Mobility Manager Entity (MME) 615 is the main controller of the eNodeBs 620 in terms of mobility functions, such as handovers. The eNodeBs 620 are the radio network nodes that are capable of sending radio messages to the mobile User Endpoints (UE) 625. The UEs 625 are the functions that represent the mobile devices such as smartphones. The interfaces 635, 640, 645 between CBC 610, MME 620, eNodeB 625, and the UE 630 are specified by the 3GPP standards. The interface 630 between the CBE 605 and the CBC 610 and the functionality of CBE 605 are not in the scope of the 3GPP standards documents. Also, the standards do not specify how warning notification messages are presented to the user of the UE 630.

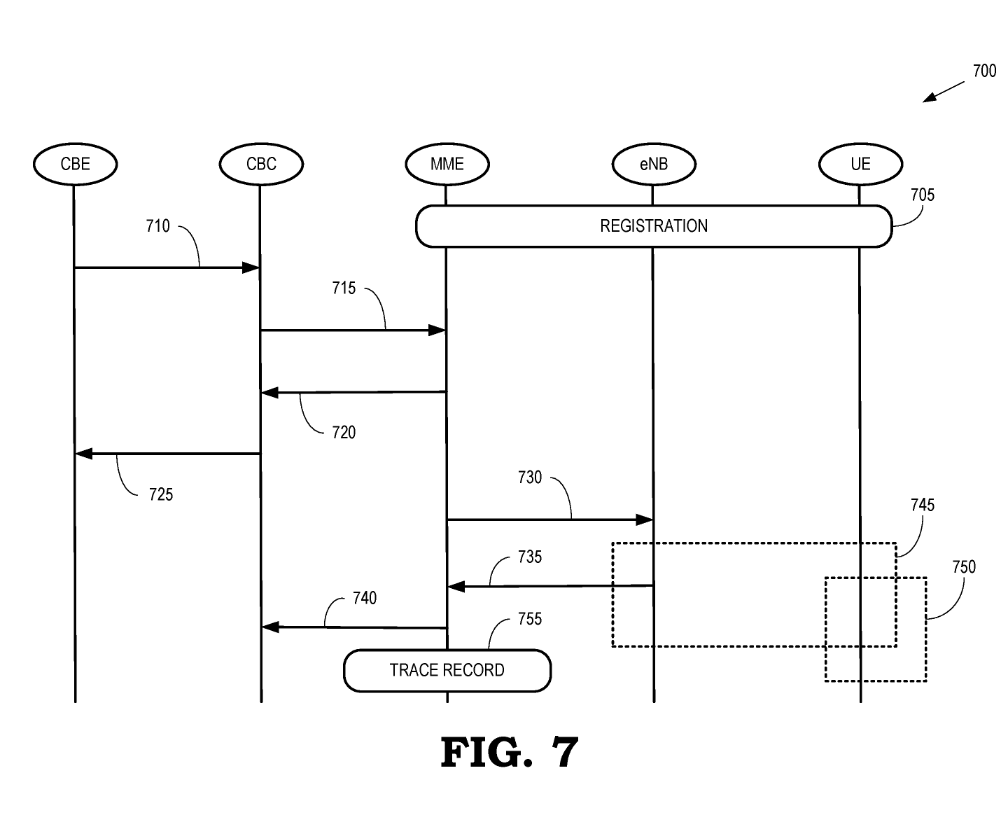

FIG. 7 is a diagram of messaging flow 700 between CBS functional components according to some embodiments. The messaging flow 700 can be implemented in some embodiments of the wireless communication system 100 shown in FIG. 1 and the wireless communication system 600 shown in FIG. 6.

At block 705, the UE, eNodeB, and the MME perform registration procedures to register the UE for wireless communication within the wireless communication system. Once the UE has been registered with the wireless communication system, emergency broadcast messages can be transmitted to the UE, as discussed herein.

At 710, the CBE transmits an emergency broadcast request to the CBC. At 715, the CBC transmits a write-replace warning request to the MME, which responds with a write-replace warning confirm message at 720. The CBC then transmits an emergency broadcast response at 725. The MME also transmits a write-replace warning request to the eNodeB in message 730. The eNodeB responds with a write-replace warning response at 735. The MME then transmits a write-replace warning indication to the CBC in message 740.

Cell broadcast delivery is performed between the eNodeB and the UE in the block 745 and the user alerting is performed by the UE in block 750. The MME records the success or failure of the message delivery process in a trace record at block 755.

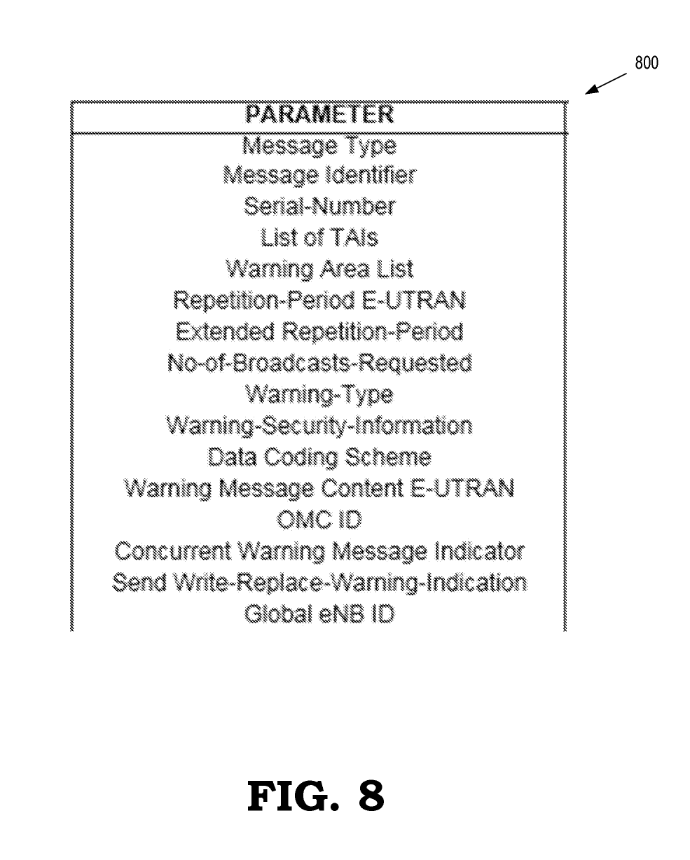

FIG. 8 is a diagram illustrating contents of a write-replace warning request message 800 according to some embodiments. Some embodiments of the techniques disclosed herein are implemented at the application level on the CBE and the UE. Consequently, some embodiments of the techniques disclosed herein may not impact the existing 3GPP standards. The content generated by some embodiments of the techniques disclosed herein are handed from CBE to CBC and the CBC is instructed to place the content in the “Warning Message Content E-UTRAN” field of a write-replace-warning-request message sent from the CBC to the MME, e.g., the message 715 shown in FIG. 7. The CBE populates the “List of TAIs”, the “Warning Area List,” and the “Global eNB ID” fields. Upon receiving the warning notification message, applications on the UE interprets the contents of the message according to some embodiments of the techniques disclosed herein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
receiving, at a server, signals indicating an alert condition for a location that is defined by a set of location attributes, wherein the alert condition is detected by a monitoring device deployed at the location;
identifying, at the server and based on the set of location attributes, at least one base station that serves at least one cell that overlaps with the location, and wherein the location encompasses less than all of the at least one cell; and
transmitting, from the server to the at least one base station, a message identifying the alert condition and including the set of location attributes.

2. The method of claim 1, wherein the set of location attributes comprises at least one of Global Positioning System (GPS) coordinates that define boundaries of the location, Galileo coordinates that define the boundaries of the location, an altitude of the location, a vehicle identifier, a building identifier, or a location identifier.

3. The method of claim 1, wherein the monitoring device comprises at least one of a camera, a motion detector, a collision warning systems, a gas detector, and a smoke detector.

4. The method of claim 1, wherein identifying the at least one base station that serves the location comprises identifying at least one base station that provides wireless connectivity within at least one geographic area that overlaps the location defined by the set of location attributes.

5. The method of claim 1, wherein transmitting the message further comprises transmitting a message including target attributes that identify at least one of a predicted time of an event associated with the alert condition, a description of the event, a type of a target node that is intended to receive the message, a type of an originating node for the event, a velocity of the originating node, or a predicted path of the originating node.

6. A method, comprising:
receiving, at a user equipment, a message identifying an alert condition and including a set of location attributes that define a boundary of a region associated with the alert condition, wherein the message is received in response to a monitoring device deployed proximate the region detecting the alert condition;
comparing, at the user equipment, a location of the user equipment to the set of location attributes in the message; and
generating, at the user equipment, an alert in response to the location of the user equipment being within the boundary of the region associated with the alert condition.

7. The method of claim 6, wherein the set of location attributes comprises at least one of Global Positioning System (GPS) coordinates that define boundaries of the location, Galileo coordinates that define the boundaries of the location, an altitude of the location, a vehicle identifier, a building identifier, or a location identifier.

8. The method of claim 6, further comprising:
determining a time interval during which the alert condition is valid.

9. The method of claim 8, wherein determining the time interval during which the alert condition is valid comprises determining the time interval based on at least one target attribute received from at least one base station, wherein the at least one target attribute comprises at least one of a predicted time of an event associated with the alert condition, a time of event origination, a velocity of an originating node of the event, or a predicted path of the originating node.

10. The method of claim 8, wherein comparing the location of the user equipment to the set of location attributes comprises comparing the location of the user equipment during the time interval of the predicted time of the event to the set of location attributes.

11. The method of claim 6, wherein receiving the message further comprises receiving a message including at least one target attribute that identifies at least one of a description of an event that caused the alert condition, a type of a target node that is intended to receive the message, or a type of an originating node for the event.

12. The method of claim 11, wherein generating the alert comprises generating the alert based on the at least one target attribute.

13. A server comprising:
a transceiver configured to receive signals indicating an alert condition for a location that is defined by a set of location attributes, wherein the alert condition is detected by a monitoring device deployed at the location; and
a processor configured to identify at least one base station that serves the location based on the set of location attributes,
wherein the transceiver is configured to transmit a message to the at least one base station identifying the alert condition and including the set of location attributes.

14. The server of claim 13, wherein the set of location attributes comprises at least one of Global Positioning System (GPS) coordinates that define boundaries of the location, Galileo coordinates that define the boundaries of the location, an altitude of the location, a vehicle identifier, a building identifier, or a location identifier.

15. The server of claim 13, wherein the monitoring device comprises at least one of a camera, a motion detector, a collision warning systems, a gas detector, and a smoke detector.

16. The server of claim 13, wherein the processor is further configured to identify at least one base station that provides wireless connectivity within at least one geographic area that overlaps the location defined by the set of location attributes.

17. The server of claim 13, wherein the transceiver is further configured to transmit a message including target attributes that identify at least one of a predicted time of an event associated with the alert condition, a description of the event, a type of a target node that is intended to receive the message, a type of an originating node for the event, a time of event origination, a velocity of the originating node, or a predicted path of the originating node.

18. A user equipment, comprising:
a transceiver configured to receive a message identifying an alert condition and including a set of location attributes that define a boundary of a region associated with the alert condition, wherein the message is received in response to a monitoring device deployed proximate the region detecting the alert condition; and
a processor configured to compare a location of the user equipment to the set of location attributes and generate an alert in response to the location of the user equipment being within the location of the alert condition.

19. The user equipment of claim 18, wherein the set of location attributes comprises at least one of Global Positioning System (GPS) coordinates that define boundaries of the location, Galileo coordinates that define the boundaries of the location, an altitude of the location, a vehicle identifier, a building identifier, or a location identifier.

20. The user equipment of claim 18, wherein the processor is further configured to determine a time interval during which the alert condition is valid.

21. The user equipment of claim 20, wherein the processor is further configured to determine the time interval based on at least one target attribute received from at least one base station, wherein the at least one target attribute comprises at least one of a predicted time of an event associated with the alert condition, a time of event origination, a velocity of an originating node of the event, or a predicted path of the originating node.

22. The user equipment of claim 20, wherein the processor is further configured to compare the location of the user equipment during the time interval to the set of location attributes.

23. The user equipment of claim 18, wherein the transceiver is further configured to receive a message including at least one target attribute that identifies at least one of a description of an event that caused the alert condition, a type of a target node that is intended to receive the message, or a type of an originating node for the event.

24. The user equipment of claim 23, wherein the processor is further configured to generate the alert based on the at least one target attribute.
